(19) United States
(12) Patent Application Publication
(10) Pub. No.: US 2010/0270395 A1
(43) Pub. Date: Oct. 28, 2010

(54) Mobile Watering Device

(76) Inventor: Stephen M Pope, Lenexa, KS (US)

Correspondence Address: STINSON MORRISON HECKER LLP;ATTN: PATENT GROUP, 1201 WALNUT STREET, SUITE 2800, KANSAS CITY, MO, 64106-2150, US

(21) Appl. No.: 12/429,296

(22) Filed: Apr. 24, 2009

(51) Int. Cl. B05B 9/00

(52) U.S. Cl. 239/140

(57) ABSTRACT

A mobile outdoor watering device. The device includes a base frame with wheels, a mounted water sprinkling element, and an elongated handle connected to the base frame. The handle comprises a water conduit and an adjustable valve for controlling the flow of water to the sprinkling element. An elbow pipe with a timer shut-off valve is connected to the handle on one side and water hose on the other side.

### CROSS-REFERENCE TO RELATED APPLICATIONS

Not Applicable.

### STATEMENT REGARDING FEDERALLY SPONSORED RESEARCH OR DEVELOPMENT

Not applicable.

### BACKGROUND OF THE INVENTION

1. Field of the Invention

The present invention relates to plant watering devices, and more particularly to portable outdoor watering devices.

2. Description of Related Art

Portable outdoor watering devices are well known. The most frequently used portable watering devices include sprinklers that are connected to a standard garden hose and manually placed in areas of a lawn or garden that require watering. More sophisticated portable sprinklers provide adjustable water flow and selective coverage, thus reducing wasting water and allowing for watering irregularly shaped yards. However, when watering large lawns, portable sprinklers must be picked up and carried or pulled to another part of the lawn, which often involves dirtying the hands while pulling along a water hose. Furthermore, an operator can easily get soaked while adjusting the spraying coverage, and fine tuning often necessitates multiple trips out into the drenched lawn.

### BRIEF SUMMARY OF THE INVENTION

The present invention is directed to a mobile outdoor watering device. In a preferred embodiment, the device comprises a base frame with a set of wheels mounted on the opposite sides of the frame. A sprinkling element is mounted on the base frame between the wheels. An elongated handle is connected to the base frame for moving the device. The handle also comprises an adjustable valve for controlling the flow of water, and a water conduit for delivering water to the mounted sprinkling element. The valve is located on the handle end opposite the base frame. An elbow pipe is connected to the handle proximate to the adjustable valve. The elbow pipe includes a timer shut-off valve for closing the water supply after a set period of time.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1 is a perspective view of a watering device according to one embodiment of the present invention;

FIG. 2 is a top plan view of the device of FIG. 1, showing the base frame, the water sprinkling element, and the wheels;

FIG. 3 is a side view of the device of FIG. 1 resting on the ground in a horizontal position; and

FIG. 4 is a side view of the device of FIG. 1 in a vertical position for adjusting its settings.

### DETAILED DESCRIPTION OF PREFERRED EMBODIMENT

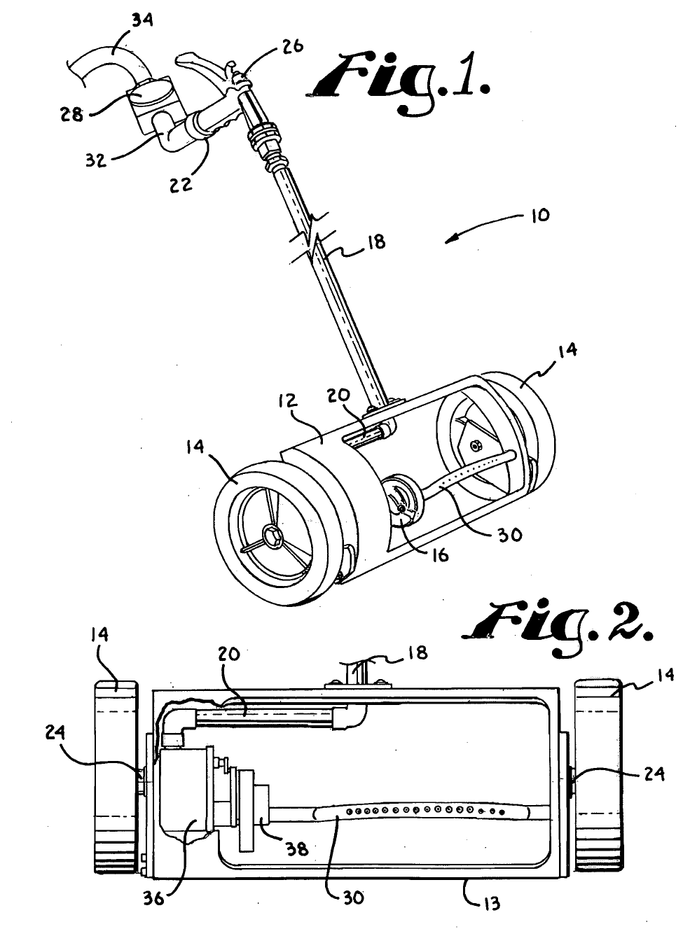

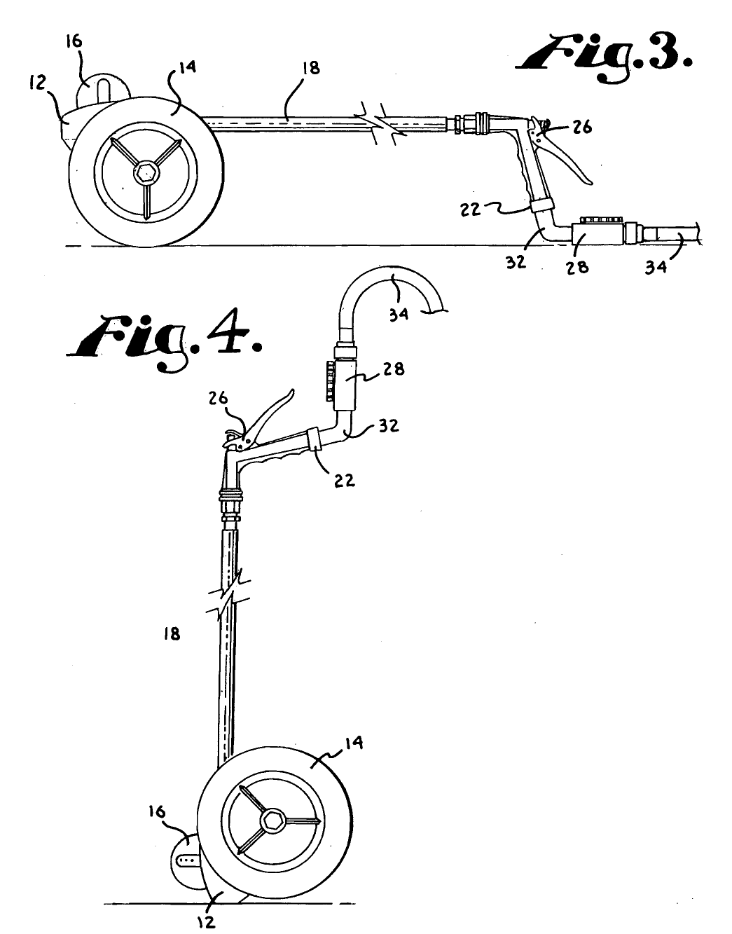

A watering device in accordance with one embodiment of the present invention is depicted in FIGS. 1 through 4.

Referring to FIGS. 1 and 2, watering device 10, in accordance with one embodiment of the present invention comprises a base frame 12, two wheels 14 rotatably mounted on axles 24, a water sprinkling element 16, and a handle 18. Handle 18 comprises a water conduit and an adjustable valve 26 for manually controlling the flow of water to sprinkler tube 30. An elbow shaped pipe 32 is coupled to a garden hose fitting 22 at the top end of handle 18 on one side, and a garden hose 34 one the other side. Elbow shaped pipe 32 comprises a timer shut-off valve 28 for shutting off the water supply after a set period of time.

In one embodiment, base frame 12 is made of metal and has a substantially rectangular shape. Axles 24 are connected to the two shorter opposite sides of base frame 12, and comprise bushings onto which plastic wheels 14 are rotatably mounted. A front edge 13 of base frame 12 extends beyond the periphery of wheels 14, thus providing a stationary resting point when device 10 is in substantially vertical position relative to the ground surface, as depicted in FIG. 4.

Handle 18 is perpendicularly connected to the side of frame 12 opposite front edge 13, thus allowing the device to be easily pushed or pulled by handle 18. Handle 18 is made of metal, and comprises a water conduit for delivering water from hose 34 to a water conduit 20. Water conduit 20 in turn delivers water to sprinkling element 16, which is mounted on base frame 12 between wheels 14.

In this embodiment, sprinkling element 16 comprises a sprinkler tube 30 with a plurality of holes for releasing water onto a plant. An oscillating mechanism 36 is powered by water pressure causing sprinkler tube 30 to oscillate back and forth, thus watering a substantially rectangular area. A knob 38 on oscillating mechanism 36 is used for adjusting the spray pattern (e.g., full (180° arc), center (stationary), left (90°) or right (90°)).

An adjustable valve 26 is located at the top end of handle 18. Valve 26 is a trigger squeeze valve that controls the flow of water in proportion to pressure exerted on the trigger by the operator. The trigger of valve 26 can also be locked in a desired position, allowing the operator to leave after making adjustments to the flow of water.

As depicted in FIGS. 1, 3, and 4, elbow 32 comprises timer shut-off valve 28 for automatically turning off the water supply after a set period of time. Timer 28 is preferably a mechanical timer with a dial for setting the period of time during which the valve will remain open. During the operation, the dial rotates indicating the time remaining for watering. When the dial aligns with zero, the valve shuts off the water supply to sprinkling element 16.

As depicted in FIG. 4, elbow 32 provides support to device 10 while preserving an unobstructed flow of water. Absent elbow 32, handle 18 would rest on hose 34, causing hose 34 to bend at the ground level, which would further result in decreased or irregular water flow, kinking of hose 34, and would ultimately damage hose 34. Furthermore, elbow 32 is adapted to support both handle 18 and base frame 12 in substantially horizontal positions, allowing sprinkling element 16 to provide equal watering of areas in front and in back of base frame 12.

Prior to using the watering device, the operator connects hose 34 to elbow pipe 32, closes valve 26, and releases water into hose 34. The operator then rolls the device, by pushing or pulling on handle 18, to a location on the lawn or garden that requires watering. After positioning the device, the operator adjusts the sprinkling range and direction of sprinkling element 16 via control knob 38 to accommodate the shape of the area that needs to be watered. The dial of timer 28 is adjusted to indicate the desired time period for watering. As depicted in FIG. 4, adjusting spray settings can be done by bringing handle 18 into a vertical position, causing wheels 14 to lift from the ground as device 10 rests on front edge 13 of base frame 12. Device 10 is thus secured from rolling away as the operator adjusts the settings of sprinkling element 16. After adjusting sprinkler element settings, the operator lays handle 18 parallel to the ground, opens valve 26, and adjusts the squeeze-trigger until the desired flow of water is achieved. Finally, the operator locks squeeze-trigger valve in place and walks away from device 10.

Making adjustments during watering is easy in comparison to other portable watering devices. For example, if the operator desires to adjust the coverage area while leaving the flow setting undisturbed, the operator using regular watering devices would have to run to the device to minimize the risk of being soaked. Device 10, on the other hand, allows the operator to stay dry by keeping his distance from water sprinkling element 16 by the length of handle 18. Furthermore, the operator can close valve 26 and take time making further adjustments without fear of getting wet. After adjusting the coverage area, the watering is resumed using the same water flow setting by simply opening valve 26.

In a scenario where the operator desires to fine tune the flow setting, the operator is spared making several trips to and from the watering device to the valve located by the house. The operator can simply reach for adjustable valve 26 on the end of handle 18 and make the desired correction in the flow of water on the spot.

Furthermore, moving device 10 to another location is easy. The operator simply approaches handle 18 of device 10 and quickly stops the water flow with squeeze-trigger valve 26, without any risk of being soaked. Device 10 is then moved to another location by simply pushing or pulling the handle in the desired direction. There is no need to separately collect and pull wet and often muddy water hose, since the hose will trail the watering device 10 as the device is moved to a new location.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth are to be interpreted as illustrative, and not in a limiting sense.

While base frame 12 and handle 18 have been described as being made of metal, other materials or combination of materials may be used, such as different types of plastic materials having sufficient sturdiness. Similarly, while wheels 14 have been described as being made of plastic, other materials or combination of materials may be used, including metal and rubber.

While base frame 12 is preferably rectangular in shape, it will be appreciated that other shapes are within the scope of the invention.

While adjustable valve 26 is preferably a trigger squeeze valve, valve 26 could be a ball or a butterfly valve.

While water sprinkling element 16 has been described as being an oscillating sprinkler, other sprinkling mechanisms may be used, including rotor and impact sprinklers.

While timer shut-off valve 28 has been described as being a mechanical timer, other timer mechanisms may be used, including electric and digital timers. Furthermore, while timer shut-off valve 28 has been described as being used to shut off the water flow after a certain period of time, timer shut-off valve 28 may be adapted to open the water flow after a specified period of time, or may be fully programmable, thus allowing for complex watering schedules.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

What is claimed and desired to be secured by Letters Patent is as follows:

1. A mobile outdoor watering device for use with a garden hose, said device comprising:
a base frame;
a wheel rotatably coupled to said base frame for moving said base frame over the ground;
a water sprinkling element mounted on said base frame for directing water onto a plant;
an elongated handle coupled with said base frame and comprising a water conduit in fluid communication with said sprinkling element; and
a garden hose fitting coupled with said handle at the top end of said handle for coupling said device to said garden hose.

2. The device of claim 1, further comprising an axle coupled to said base frame for providing support to said base frame for moving over the ground, and wherein said wheel comprises at least two wheels mounted on said axle.

3. The device of claim 2, wherein said sprinkling element is mounted on said base frame between said wheels.

4. The device of claim 1, wherein said handle includes an adjustable valve in fluid communication with said water conduit for regulating the flow of the water.

5. The device of claim 4, wherein said adjustable valve is a squeeze-trigger valve.

6. The device of claim 1, further comprising an elbow shaped pipe in fluid communication with said water conduit, wherein said pipe is proximate to said garden hose fitting, and wherein said pipe is adapted to support said handle and said base frame in substantially horizontal positions.

7. The device of claim 1, further comprising a timer shut-off valve in fluid communication with said water conduit for shutting off the water flow after a set period of time.

8. The device of claim 1, wherein said water sprinkling element comprises a tube in fluid communication with said water conduit,.said tube including a plurality of holes for releasing water onto said plant.
